(19) United States
(12) Patent Application Publication
(10) Pub. No.: US 2012/0316659 A1
(43) Pub. Date: Dec. 13, 2012

(54) Coaching Strategies in Fantasy Sports

(76) Inventor: Mark Andrew Magas, Northbrook, IL (US)

(21) Appl. No.: 13/492,864

(22) Filed: Jun. 10, 2012

Related U.S. Application Data
(60) Provisional application No. 61/494,926, filed on Jun. 9, 2011.

(51) Int. Cl. G06F 19/00

(52) U.S. Cl. 700/91

(57) ABSTRACT

The present invention allows fantasy sports team owners to have more of an impact on the performance of their fantasy sports team. Fantasy owners set “coaching strategies” for their individual teams that give different bonuses/penalties depending on which strategy or counter-strategy is selected.

### CROSS-REFERENCE TO RELATED APPLICATIONS

This application claims the benefit of U.S. Provisional Application No. 61/494,926, filed Jun. 9, 2011.

### BACKGROUND OF THE INVENTION

A fantasy sports league consists of at least two fantasy owners who manage hypothetical teams consisting of multiple real-life players from a corresponding real-life sports league. A fantasy league can be created for nearly any major professional sport, such as football (NFL), baseball (MLB), basketball (NBA), hockey (NHL), soccer (MLS) etc.

Each team has a limited amount of roster spots available. Players are usually separated by the position they play (e.g., quarterback, running back, wide receiver). Players are traditionally selected in some form of a draft involving all of the fantasy owners. The fantasy owners can select any player in the league for their fantasy teams. Players can be selected independent of their real-life teams. In general, the fantasy game starts with a draft sometime before the start of the season. The draft can be done by various methods (e.g., snake draft or auction). In the draft, the fantasy owners pick players to fill up their rosters according to the fantasy league's roster settings.

An example of roster settings is shown in FIG. 4—It shows the roster size is 14 comprising 9 starters and 5 players on the bench. Fantasy owners need to have at least a full starting lineup or else their roster is invalid. Fantasy owners need to stay within the roster limits (e.g., 14) and position “Maximum” limits (e.g., 4 QB). Any players that selected that exceed the number of players needed as starters will be on the bench. The players on the bench are a pool of extra players that the fantasy owner can switch into the starting lineup as needed. Fantasy owners set their starting lineup for every scoring period (e.g., a week).

After the draft, any player that is not selected goes into a free agency pool. Fantasy owners are able to manage their roster by adding or dropping players to the free agency pool.

The fantasy team scores points according to the real-life performance of the fantasy team's players. Only players that are in the active roster (Starters) contribute to the teams scoring. Points are accumulated based on predetermined statistical categories that are relevant in each respective sport. There are two main types of scoring formats: rotisserie scoring, and head to head matchup scoring.

In head to head scoring, two fantasy teams are matched against each other for a certain period of time (e.g., a week) called a scoring period. During the scoring period, each fantasy team accumulates points based on the real-life performance of their team's players according to a pre-defined scoring method set by the league manager. A head to head scoring method for a fantasy football league is shown in FIG. 5. Various statistics are listed in FIG. 5 and are associated with a number of points for each statistic reached based on player position. Whichever fantasy team has the most points during a particular scoring period gets a win, while the other gets a loss. There are multiple scoring periods in a season, and teams will alternate which team they are matched against according to a schedule. At the end of the season, the team with the most wins or the team that wins a playoff tournament is deemed the winner. An example of a weekly matchup in a head-to-head scoring system is shown in FIG. 5. Table 1 shows the statistics for John Kitna for Week 11 scoring period of the fantasy season corresponding to Week 16 of the actual 2010 NFL season:

TABLE 1
Head to Head Calculation

| | # from FIG. 2 | Scoring statistic from FIG. 4 | Calculation | Points |
|---|---|---|---|---|
| C/A (completed | 12/20 | 0.1 points per completed pass | 0.1 × 12 | 1.2 |
| passes/attempted | | | | |
| passes) | | | | |
| Passing Yards | 115 | 1 point per 25 yards | 1 × (100/25) | 4 |
| Touchdown Pass | 1 | 4 points per touchdown pass | 4 × 1 | 4 |
| Interceptions | 2 | −2 points per interception | 2 * −2 | −4 |
| Rushing Yards | 7 | 1 point per 10 yards | 7 × 0 | 0 |
| Sacks | 4 | −0.2 points per sack | | −0.8 |

| | |
|---|---|
| Total Points | 4.4 |

2. In rotisserie scoring, a fantasy team's performance in certain statistical categories (e.g., number of touchdowns, number of interceptions) is aggregated across the entire fantasy season. Fantasy teams are ranked against the other fantasy teams in the league in each of the statistical categories (e.g., in a 10 team league, the team with the most touchdowns on the year ranks 1/10 while the team with the least touchdowns ranks 10/10). The fantasy team that ranks highest overall averaged across all categories at the end of the fantasy season is deemed the winner. In rotisserie scoring, individual player performance (e.g., # of rushing yards) does not translate into points.

In fantasy sports, owners have had limited options in affecting their team's outcome outside of managing their roster and setting their active lineups. Currently the only strategic options available to an owner are related to managing the roster—including (1) which players are in the starting lineup, (2) which players to pick up from free agency and which players to drop from the team, and (3) which players to trade with other fantasy owners.

There exists a need to give fantasy owners more options in team management besides just selecting the players of their fantasy teams.

### DESCRIPTION OF THE PRIOR ART

U.S. Patent Publication No. 20100279754 disclosed by Tanenbaum discloses a fantasy sports system in which fantasy owners to give their players arbitrary bonuses (and penalties) to for achieving (or not achieving) a wagered statistical goal. In Tanenbaum's example, if a fantasy owner owns a player that has a high stolen base record, the fantasy owner can choose to give that player a bonus for future stolen bases. The problem with this method is that the bonuses do not actually mimic real-life team management. In real life, there would be consequences to using a base stealing strategy—although that particular player may have a good possibility of stealing bases, using that strategy, there also is a significant chance that that player would get caught stealing—resulting in an out and lowering the number of at bats possible for your team. With less at bats, there would be less hits, home runs, strikeouts, etc for the whole team. Tanenbaum also does not apply a bonus to anything other than a single player.

### SUMMARY OF THE INVENTION

The present invention allows owners to have more of an impact on the performance of their fantasy team beyond the standard roster management. Fantasy owners set “coaching strategies” for their individual teams which give different bonuses and/or penalties to certain team members depending on which strategy or counter-strategy is selected. The bonuses/penalties resulting from applying a coaching strategy to a fantasy team mimics real-life coaching.

As a result of a real-life coach instructing a player or group of players to play aggressively, the aggressive player(s) will have effects (whether positive or negative) on other team members and the opposing team members. For example, if a manager decides to have his players make six attempts at stealing a base in a baseball game, and the players get caught on three of those attempts, that strategy would be blamed for costing the team three outs (an entire innings worth of outs). The present invention mimics this coaching strategy by allowing a fantasy baseball owner to set a stealing base strategy which might give 50% extra points to the players that successfully steal bases, but might also then give 20% in penalties to the batting statistics to the whole team—since in real life, a stealing base strategy would likely cost a team some outs. The present invention allows bonuses and penalties to affect the entire team in a manner which is more consistent with real-life coaching decisions.

Maximizing use of (giving a bonus to) a particular player or group of players can adversely affect (give a penalty to) other players. As another example, if a real-life hockey manager has a very strong center, a coach would want to maximize his time with the puck—the coach would instruct the other team members to get the puck to the center, whenever possible. If the center has the puck the most, the center has the greatest scoring potential. This coaching strategy, however, would limit the other players' ability to score. To mimic this coaching strategy, the present invention would give a bonus to a star player, and corresponding penalty to the other members of the team.

These bonuses and penalties give a strategic advantage to the fantasy team owner that outthinks the other. A fantasy owner that anticipates his opponent's strategies will have an advantage over any opposing fantasy team. Coaching strategies can allow for a fantasy team with mediocre players to have a fighting chance to get a win against a fantasy team with top players.

### BRIEF DESCRIPTION OF THE DRAWINGS

FIG. 1 is an example roster from a prior art Fantasy Football league.

FIG. 2 is an example head-to-head scoring sheet from a matchup between two teams in a prior art fantasy football league.

FIG. 3 is a more detailed breakdown of the matchup between two teams shown in FIG. 2.

FIG. 4 is a listing for the roster limits for the fantasy football league shown in FIGS. 1-3.

FIG. 5 is a listing of the point scoring details for the fantasy football league shown in FIGS. 1-3.

FIG. 6 is an example of a head-to-head fantasy football league's standings according to the present invention and the prior art.

FIG. 7 is an example of a head-to-head fantasy team's roster from the fantasy football league shown in FIG. 6 according to the present invention and the prior art.

FIG. 8 is an example of a head-to-head free agents listing from the fantasy football league shown in

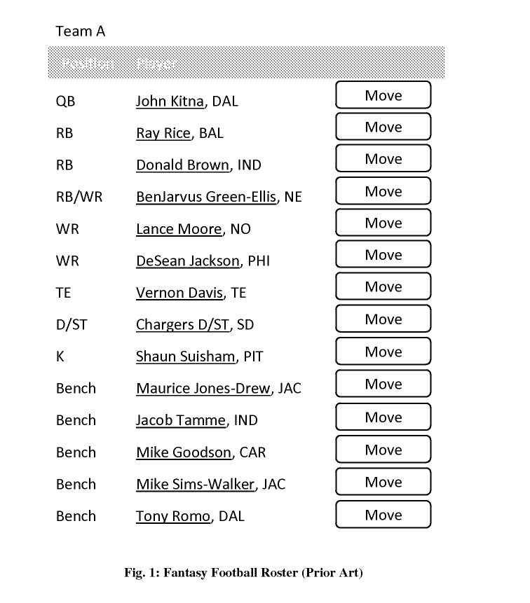

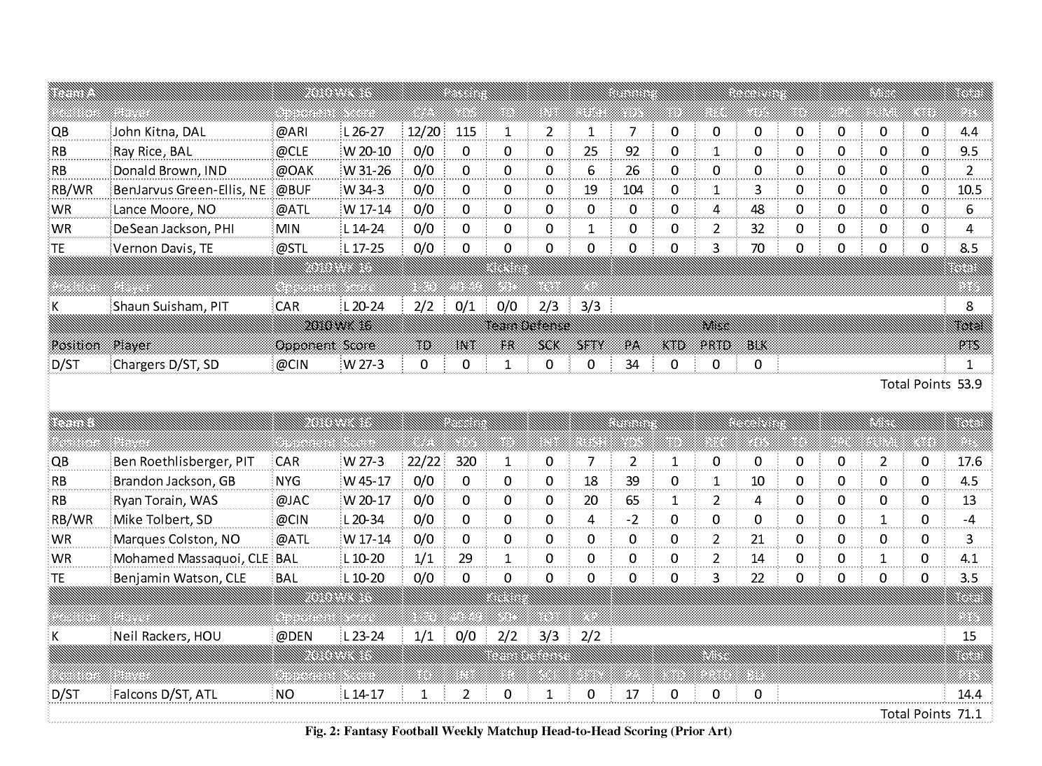

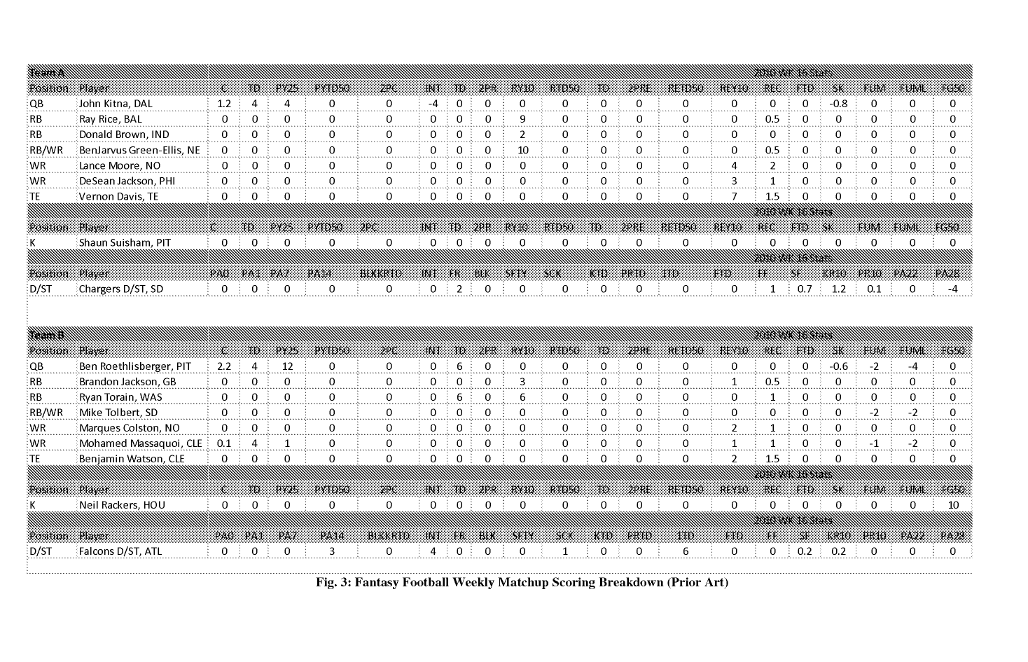

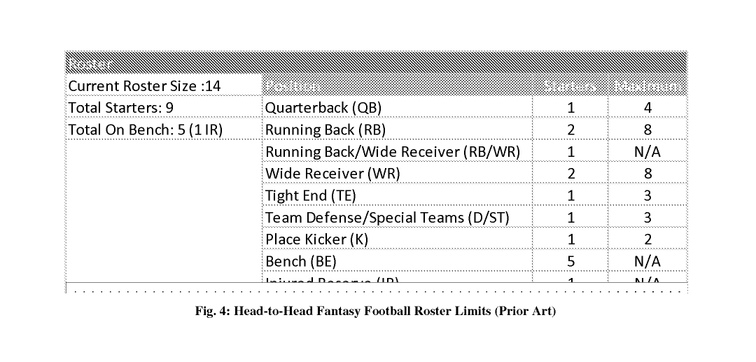

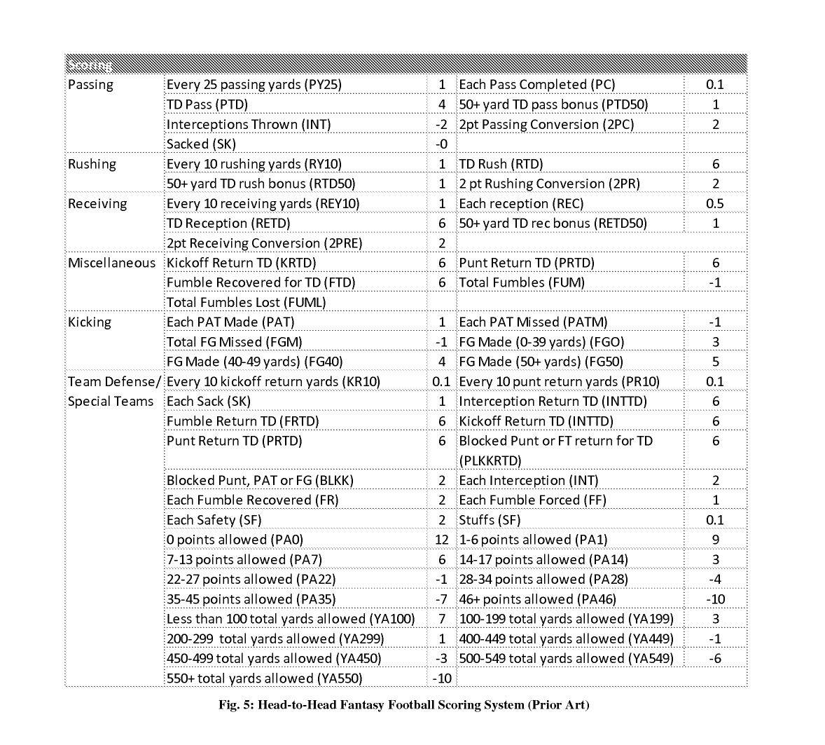

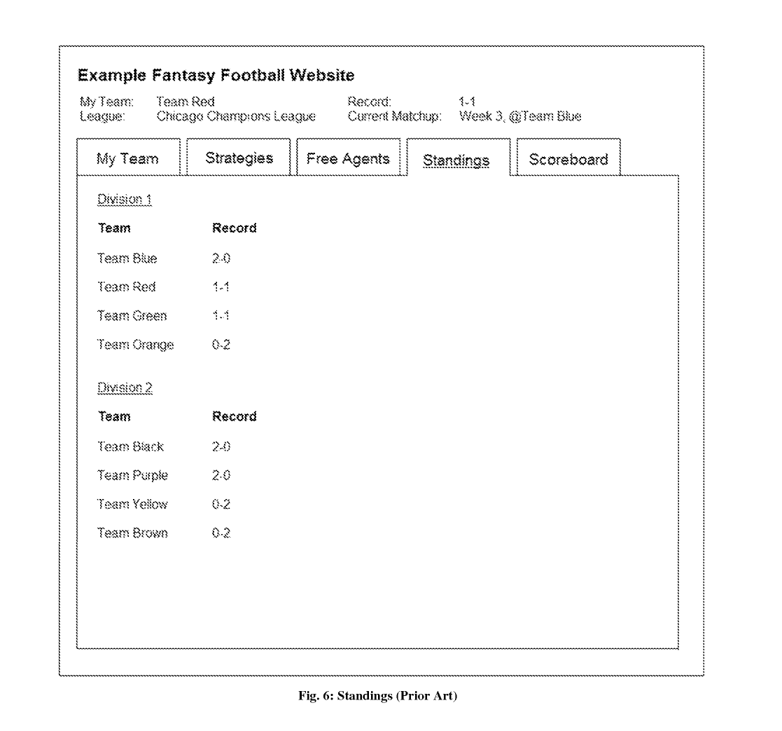

FIG. 6 according to the present invention and the prior art.

FIG. 9 is an example of a head-to-head strategy selection by the fantasy baseball team's owner according to the present invention.

FIG. 10 is an example of a head-to-head fantasy scoreboard for the fantasy football league shown in FIG. 6 for a particular week.

FIG. 11 is an example of a head-to head matchup (points breakdown) between two teams in the fantasy football league shown in FIG. 6 according to the present invention.

FIG. 12 is an example of a rotisserie scoring fantasy baseball league's standings according to the present invention and the prior art.

FIG. 13 is an example of a rotisserie scoring fantasy team's roster from the fantasy baseball league shown in FIG. 6 according to the present invention and the prior art.

FIG. 14 is an example of a rotisserie scoring free agents listing from the fantasy baseball league shown in FIG. 6 according to the present invention and the prior art.

FIG. 15 is an example of a rotisserie scoring strategy selection by the fantasy baseball team's owner according to the present invention.

FIG. 16 is an example of a rotisserie scoring fantasy daily results table for the fantasy baseball league shown in FIG. 6 as of June 5^{th}.

FIG. 17 is an example of a head-to-head fantasy team's roster for a fantasy hockey league according to the present invention and the prior art.

FIG. 18 is an example of a head-to-head strategy selection by the fantasy hockey team's owner according to the present invention.

FIG. 19 is an example of a head-to head matchup (points breakdown) between two teams in the fantasy hockey league according to the present invention.

FIG. 20 is an example of a head-to-head fantasy scoreboard for the fantasy hockey league for a particular week.

### DETAILED DESCRIPTION OF THE INVENTION

The present invention is an improvement over traditional fantasy sport software such as what can be found on ESPN.com, CBSsports.com, and fantasysports.yahoo.com.

The present invention includes a computer or other suitable processing system with application software and a communication network, such as the Internet. The present invention provides a graphical user interface (GUI) for the entry of data, such as the players selected for each fantasy team on the front end and real-life statistics of each player on the back end. The GUI also presents information, such as in a graphical manner, to show the statistics of fantasy teams, the players on those teams, the statistics of the individual players on each fantasy team, and the standing of those fantasy teams relative to one another. The invention can also display the fantasy owners of each fantasy team in a particular fantasy league, the total number of fantasy teams per fantasy league, a competition schedule, coaching strategies selection, and other information related to planning, organizing, running, managing, or participating in the fantasy sports league or fantasy sports team within the league. Table 2 shows the methods in which bonuses may be applied to a team's score or roster.

TABLE 2
Coaching Strategies

| | | | | Preferred | |
|---|---|---|---|---|---|
| | Bonus | | | Scoring | Example |
| | Method | Description of Bonus | Example | System | Sport |
| 1 | STATISTIC | Give | For every 10 rushing yards | Head to | Hockey |
| | POINT | bonuses/penalties to | earned, the fantasy team | Head | |
| | BONUS | fantasy points scored | earns 1.5 fantasy points | | |
| | | for specific statistics | rather than 1 fantasy point | | |
| 2 | ACTUAL | Give | For every 10 rushing yards | Rotisserie, | Baseball |
| | STATISTIC | bonuses/penalties to | earned, the fantasy team | Head to | |
| | BONUS | actual statistics earned | earns 15 rushing yards | Head | |
| 3 | POSITION | Give | For every 1 fantasy point | Head to | Football, |
| | POINT | bonuses/penalties to | earned by a running back, | Head | Hockey, |
| | BONUS | all fantasy points | the fantasy team earns 1.3 | | Baseball |
| | | scored by all players | fantasy points | | |
| | | of a certain position | | | |
| 4 | PLAYER | Give | For every 1 fantasy point | Head to | Football, |
| | POINT | bonuses/penalties to | earned by Player A, the | Head | Hockey, |
| | BONUS | all fantasy points | fantasy team earns 1.3 | | Baseball |
| | | scored by a specific | fantasy points | | |
| | | player | | | |
| 5 | ROSTER | Change the starting | Fantasy team receives an | Rotisserie, | Any |
| | LIMIT | roster limits | extra wide receiver slot | Head to | |
| | BONUS | | | Head | |
| 6 | LINE | Give | For every 1 fantasy point | Head to | Team sport |
| | BONUS | bonuses/penalties to | earned by players on Line 1, | Head | such as |
| | | all fantasy points | the fantasy team earns 1.3 | | Football, |
| | | scored by a specific | fantasy points. | | Hockey, |
| | | line on a fantasy team | | | Baseball |

In the simplest bonus methods such as the Statistic Point Bonus and Actual Statistic Bonus methods, selecting a particular strategy will give a bonus and possibly a penalty by way of a points multiplier or increasing/decreasing the actual statistics for a fantasy owner's team.

In the Position Point Bonus method, selecting a particular strategy may give a bonus and/or a penalty to either or both the fantasy owner's and his opponent's teams. Various combinations and types of bonuses and penalties are possible.

Combining one of the Position Point Bonus method or the Player Point Bonus method with the Line Bonus method, when a fantasy roster is set with lines, the amount of bonuses/penalties awarded from a particular strategy for each player or players of a certain position can depend on the line each player is on.

### Strategy Groupings

Strategies may be organized into pre-determined groups to aid in the fantasy owner's strategy selection. Possible strategy groupings include but are not limited to:
1. Offensive Strategies/Defensive Strategies
2. Strategies that give bonuses to a particular position (e.g., QB, RB, WR, K)
3. Strategies that give bonuses to the owner's/opponents' team
4. Strategies that give bonuses to a particular line type (e.g., power play line in hockey)

The league owner will have the ability to choose how fantasy owners can select strategies. For example, the league owner might require that one strategy may be selected within each of the strategy groupings. The league manager may instead permit the fantasy owner to select multiple strategies at the same time. The availability of a large variety of coaching strategies will give fantasy owners a tremendous flexibility in anticipating and countering future moves of his opponents.

### Options in Applying Strategies

Because real-life coaching strategies change from game to game, the selected coaching strategies (which give certain bonuses and penalties) can be changed for each scoring period.

Upon switching to a new strategy, the effectiveness of a strategy may be phased-in over time, reflecting the time it would take a real-life team to learn and adapt to a new strategy. For example, a strategy may take 4 scoring periods (e.g., weeks) to reach full effectiveness. For the first week, the strategy would only give 25% of its said bonuses. In the second week, the strategy may give 50%, and so on. The phase-in of the bonuses and penalties (for more advanced strategies that give drawbacks) do not necessarily have to be equal. Additionally, bonuses and penalties can have differing phase-in schedules—a bonus might phase in over multiple scoring periods, penalties may always be at full effect.

Strategies can either be (1) locked in for a period of time (such as one or more scoring periods), or (2) updated at any time (e.g., during the middle of a real-life game). Although possible to calculate when a strategy changes mid-scoring period, this would add a layer of complexity into programming the fantasy sport website.

### Strategy Levels

There are different levels of implementation of this invention. Four such levels and example strategies are laid out below and have increasing levels of sophistication:
1. Basic Strategies: Bonuses are given to owner's team (or selected team members)
2. Intermediate Strategies: Bonuses with associated penalties are given to the owner's team (or selected team members)
3. Advanced Strategies: Bonuses with associated penalties are given to the opponent's team (or selected team members)
4. Expert Strategies: Bonuses and associated penalties are given to the owner's team and the opponent's team (or selected team members) in a single strategy.

The actual selection of strategies available for a particular league may be comprised of strategies from any strategy level described above. Any number of strategies may be required, and strategies may be organized in groups as previously outlined.

Four examples of possible implementations of the invention are detailed below for fantasy football. Fantasy Football was chosen as an example of how the invention might be carried out in a head to head scoring system because head to head scoring is very common for fantasy football leagues. The player positions common in fantasy football include, but are not limited to, quarterback, running back, wide receiver, team defense, and kicker.

### EXAMPLE FANTASY FOOTBALL COACHING STRATEGIES AND LEVELS

### Example 1

### Only Basic Strategies

Basic strategies are the least complex and would be best for a more casual fantasy league. At the beginning of the scoring period, a fantasy owner will take a look at his team and will determine which of his players have the greatest probability of gaining the most points for his team. The fantasy owner will then select a strategy from strategies such as those listed below that will likely give his team the largest advantage. This example shows a setup where only one strategy must be selected from a single strategy group.
Spread Formation I (passing strategy)—gives 20% bonus to points scored by quarterbacks and wide receivers on the owner's team
Split Back Formation I (running strategy)—gives 30% bonus to points scored by running backs on the owner's team
I-Formation I (balanced strategy)—gives 10% bonus to points scored by quarterbacks, wide receivers, and running backs on the owner's team
Star Player I—gives 50% bonus to points scored by one selected player
Extra Man I—gives 1 additional starting roster slot for either a wide receiver or running back

### Example 2

### Intermediate Strategies and Below

With intermediate-level strategies, the fantasy owner must now not only predict which of his players have the greatest chance of scoring, the fantasy owner must also now consider the corresponding drawbacks of a particular strategy. For example, because the Spread Formation II coaching strategy (see below) focuses on quarterbacks and wide receivers, running backs are ignored and thus given a penalty. The fantasy owner would choose the Spread Formation II strategy when the owner has a very strong quarterback and mediocre running backs. Similar to Example 1, this example also shows a setup where only one strategy must be selected from a single strategy group. Note that not all strategies in this example are intermediate level strategies; I-Formation I and Extra Man I are basic strategies and do not have any penalty. For the purpose of balancing strategies to be fair for all players, combinations of strategies from different levels may be necessary.
Spread Formation II (passing strategy)—gives 20% bonus to points scored by quarterbacks and wide receivers, but 30% penalty to running backs on the owner's team
Split Back Formation II (running strategy)—gives 30% bonus to running backs, but 20% penalty to quarterbacks and wide receivers on the owner's team
I-Formation I (balanced strategy)—gives 10% bonus to points scored by quarterbacks, wide receivers, and running backs on the owner's team
Star Player II—gives 50% bonus to points scored by one selected player, but points from all other players reduced by 10%
Extra Man I—gives 1 additional starting roster slot for either a wide receiver or running back

### Example 3

### Advanced Strategies and Below

Advanced strategies give the fantasy owner the ability to affect the opponent's team. FIG. 9 shows a fantasy owner selecting both a strategy and a counter strategy. This mimics the ability of a real-life coach to anticipate and react to an opposing team's strengths and weaknesses. Two strategy groups are used in this example—strategies and counter strategies. The fantasy owner may select one strategy from each group. Note that multiple strategy groups may be used for any level of strategies and is not restricted to being used for advanced strategies and above.
Strategies (affects owner's team)
   Spread Formation II (passing strategy)—gives 20% bonus to points scored by quarterbacks and wide receivers, but 30% penalty to running backs on the owner's team
   Split Back Formation II (running strategy)—gives 30% bonus to running backs, but 20% penalty to quarterbacks and wide receivers on the owner's team
   I-Formation I (balanced strategy)—gives 10% bonus to all points scored by quarterbacks, wide receivers, and running backs on the owner's team
   Star Player II—gives 50% bonus to points scored by one selected player, but points from all other players reduced by 10%
   Extra Man I—gives 1 additional starting roster slot for either a wide receiver or running back
Counter Strategies (affects opponent's team)
   Prevention III (anti-passing strategy)—gives 20% penalty to all points scored by opponent's quarterback and wide receiver, but gives 30% bonus to all points scored by opponent's running back
   Crowd the Box III (anti-running strategy)—gives 30% penalty to all points scored by opponent's running backs, but gives 20% bonus to all points scored by opponent's quarterbacks and wide receivers
   4-3 III (balanced strategy)—gives 10% penalty to all points scored by opponent
   Shutdown Star Player III—gives 50% penalty to points scored by one selected player on opponent's team, but reduces points by all players on owner's team by 10%

### Example 4

### Expert Strategies

Expert strategies are the most complex strategies. The fantasy owner must now consider the potential effect of each strategy chosen for both the owner's team and the opponent's team. In this example, three strategy groups are used—offense, defense, and special teams. The fantasy owner may select one strategy from each group.
Offense
   Spread Formation IV (passing strategy)—gives 20% bonus to points scored by quarterbacks and wide receivers, but 30% penalty to running backs on the owner's team. Additionally, opponent receives a 100% bonus to points for interceptions and passing yards allowed against the opponent's defense count as 20% more.
   Split Back Formation IV (running strategy)—gives 30% bonus to running backs, but 20% penalty to quarterbacks and wide receivers on the owner's team. Additionally, opponent receives a 100% bonus to points for fumbles and running yards allowed by opponent's defense count as 30% more.
   I-Formation I (balanced strategy)—gives 10% bonus to all points scored by quarterbacks, wide receivers, and running backs on the owner's team. Additionally, all yards allowed by opponent's defense count as 10% more
   Star Player II—gives 50% bonus to points scored by one selected player, but points from all other players reduced by 10%.
   Extra Man I—gives 1 additional starting roster slot for either a wide receiver or running back
Defense
   Blitz IV (turnover strategy)—gives 50% bonus to defense points for interceptions, fumble recoveries, and sacks, but 20% penalty to points for yards allowed and points allowed. Additionally, opponent receives 10% bonus to points scored by the quarterback.
   4-3 II (balanced strategy)—gives 40% bonus to all defense points.
   Prevention IV (anti-passing strategy)—gives 20% penalty to all points scored by opponent's quarterback and wide receiver, but gives 30% bonus to all points scored by opponent's running back. Additionally, rushing yards against the fantasy owner team's defense count as 20% more.
   Crowd the Box IV (anti-running strategy)—gives 30% penalty to all points scored by opponent's running backs, but gives 20% bonus to all points scored by opponent's quarterbacks and wide receivers. Additionally, passing yards allowed by the fantasy owner team's defense count as 20% more.
   Shutdown Star Player III—gives 50% penalty to points scored by one selected player on opponent's team, but reduces points by all players on owner's team by 10%.
Special Teams
   Field Position IV (kicking strategy)—gives 30% bonus to points scored from field goals, but opponent receives 20% bonus to yards gained on kick returns.
   Return Specialist I (kick return strategy)—gives 50% bonus to yards gained on kick returns
   Go For 2 II (extra points strategy)—gives 1 point bonus to all ‘point after touchdowns (PATs)’, but reduces points scored for field goals by 20%

### FANTASY FOOTBALL EXAMPLE—HEAD TO HEAD SCORING

Fantasy football is used as a first example to illustrate how the invention can be used for head to head scoring leagues. The head to head scoring system is based off of points attained by players achieving various statistics, such statistics as shown in FIG. 5.

In the preferred embodiment, both fantasy teams in a matchup will have the ability to select a strategy and a counter strategy as described above as the “Advanced Strategies”. FIG. 6 through FIG. 8 are used to discuss the background of the invention and are prior art. FIG. 9 shows the “Advanced Strategies” embodiment (as discussed above) in the format of a weekly head to head matchup because the head to head matchup is currently the most common scoring method in fantasy football.

FIG. 6 shows the standings for the Chicago Champions League, a fantasy football league. The view of the standings is that of one of the fantasy owner of Team Red. As of the beginning of week 3, Team Red has one won game and lost one game. Note that all teams in the league have played two games going into week 3. Each fantasy owner will see a similar screen with the same statistics.

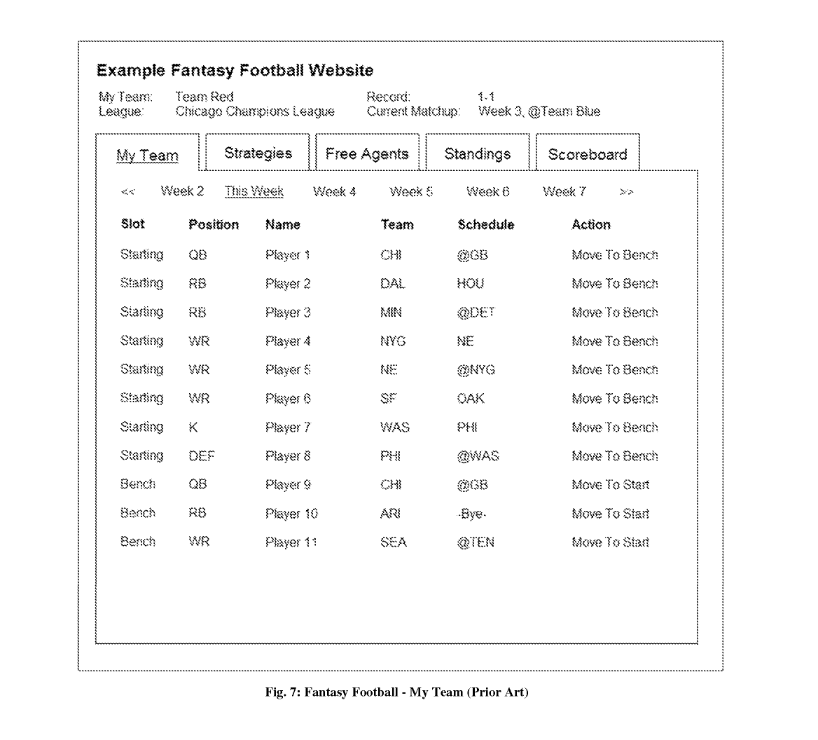

FIG. 7 shows Team Red's roster going into week 3. These players that are currently on Team Red were either:
1. Selected in the draft; or
2. Acquired through free agency or by trading with other owners since the draft.

The players in the “Starting” slots (1QB, 2RB, 3WR, 1K, 1DEF) are the only players that score points for the respective fantasy team each week. The number of starting slots is limited based on league settings set by the league manager. The fantasy owner needs to choose the starting players based on which players have the greatest chance of accumulating the most points in a given week. The bench is used to reserve players to play in the following weeks or to prevent other fantasy owners from acquiring the players. On this screen a fantasy owner will select the players for the starting line up and move the remaining players to the bench (by clicking on the “Move to Bench” link under the Action column). Depending on the league settings, the fantasy owner will likely have to select a lineup each week.

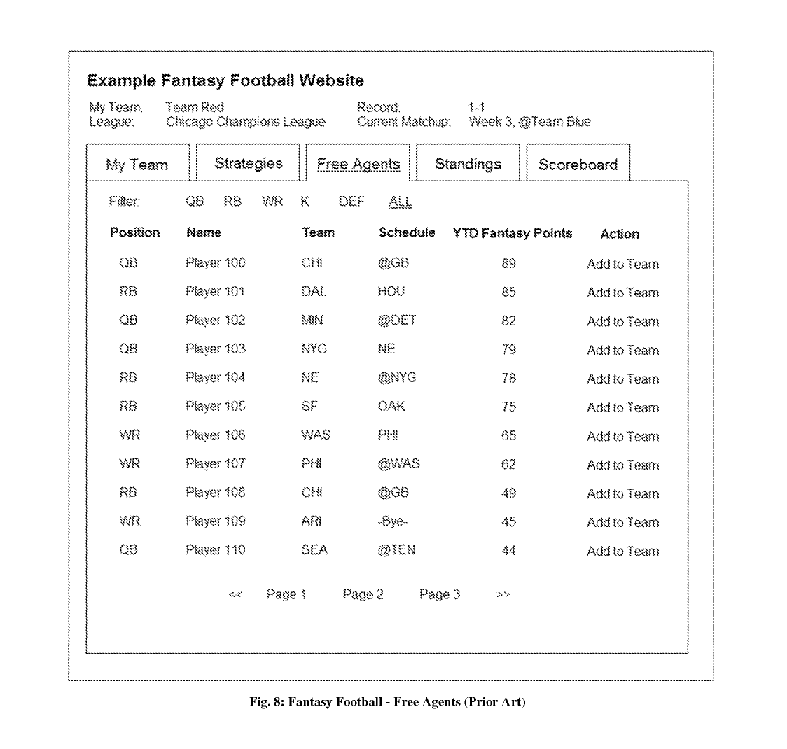

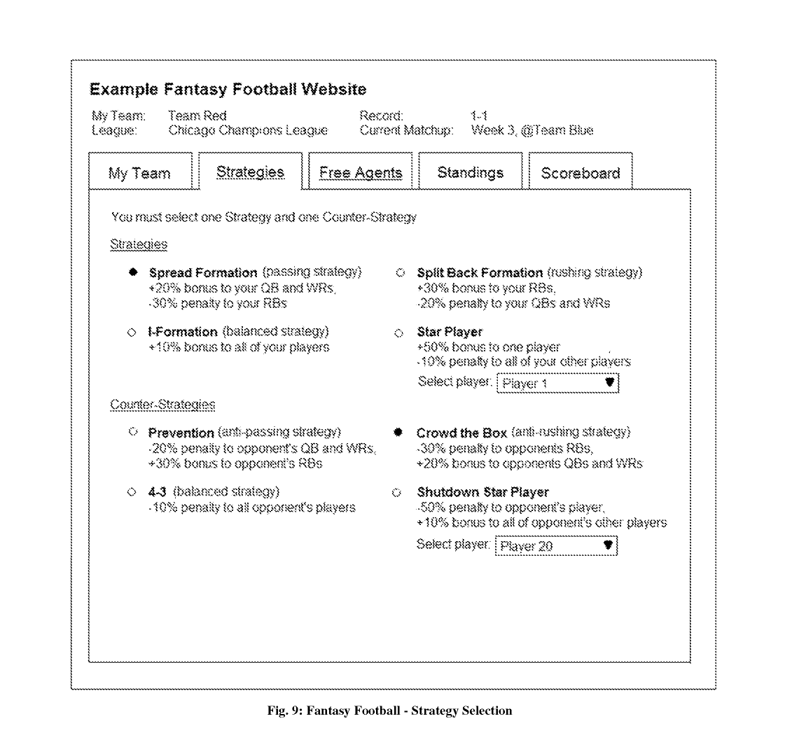

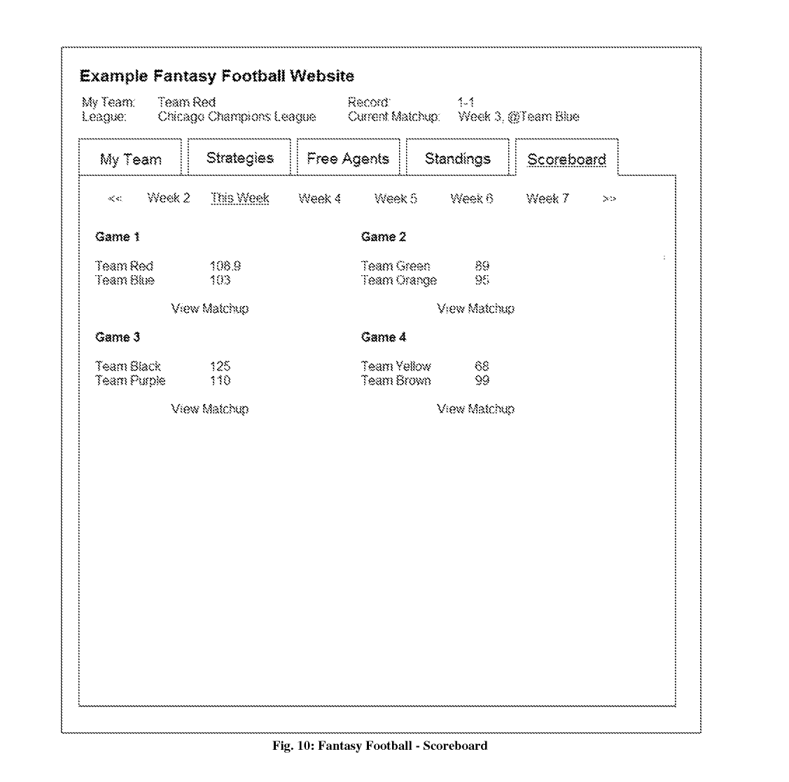

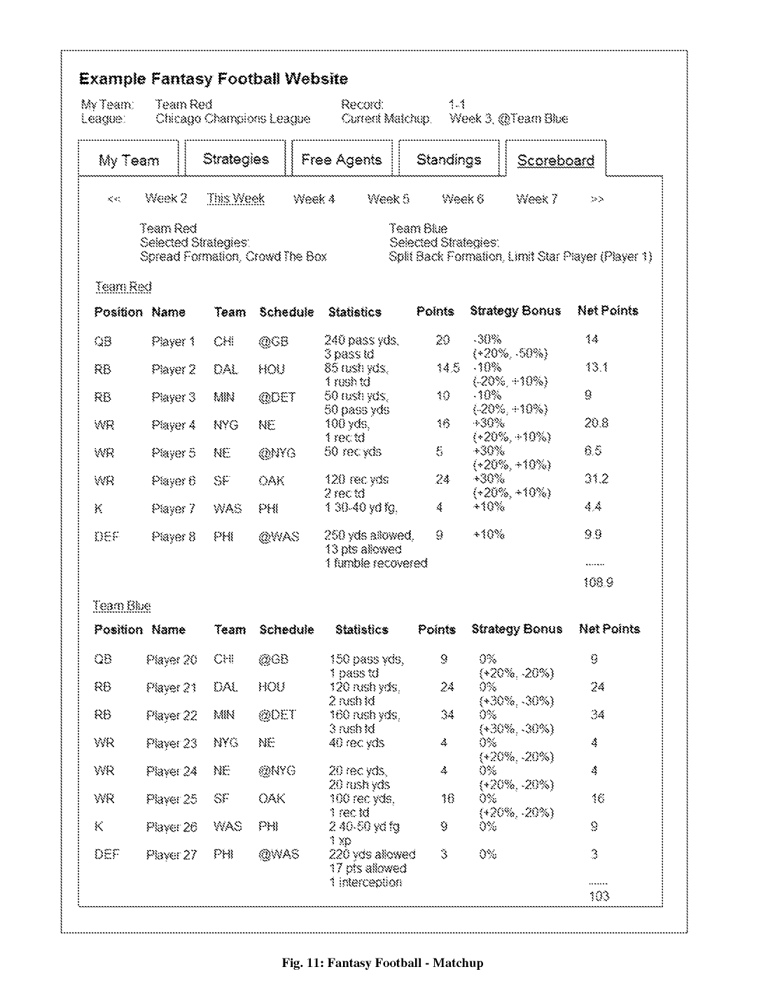

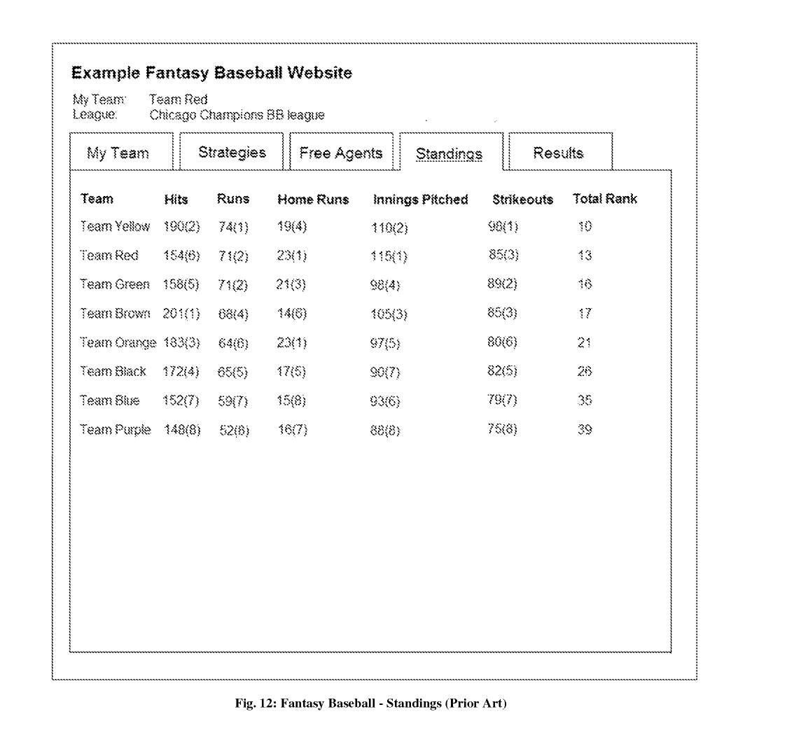

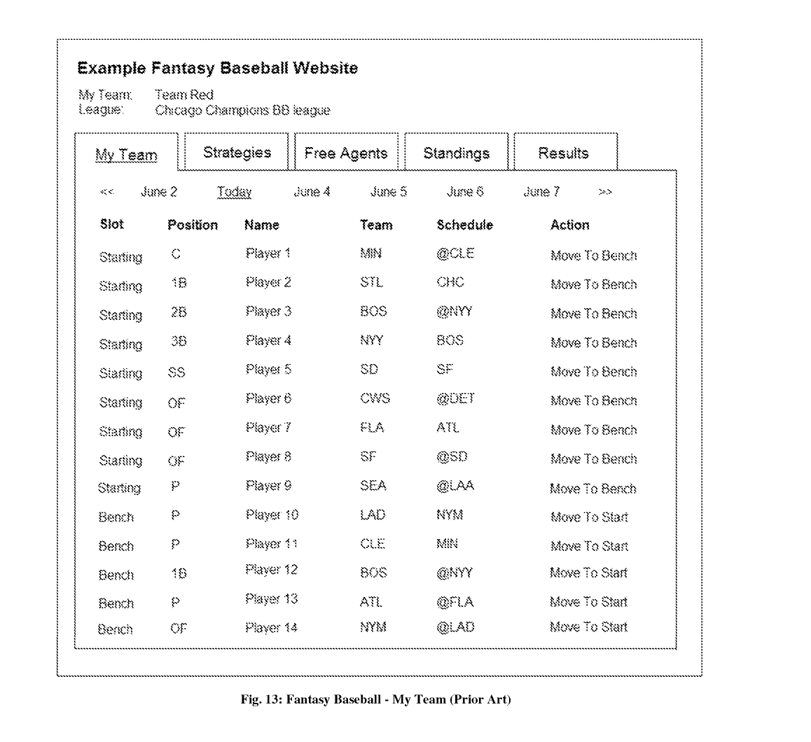

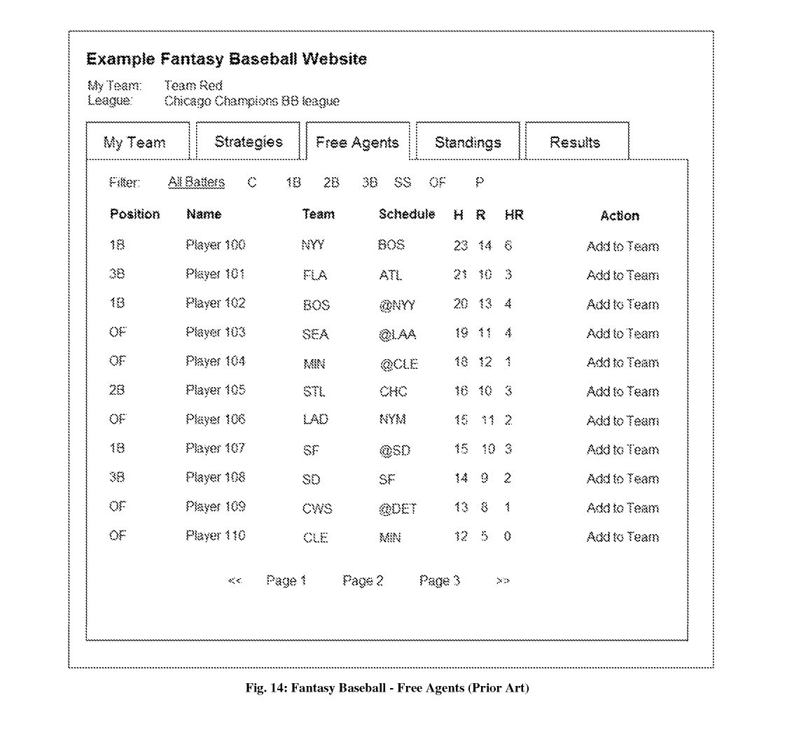

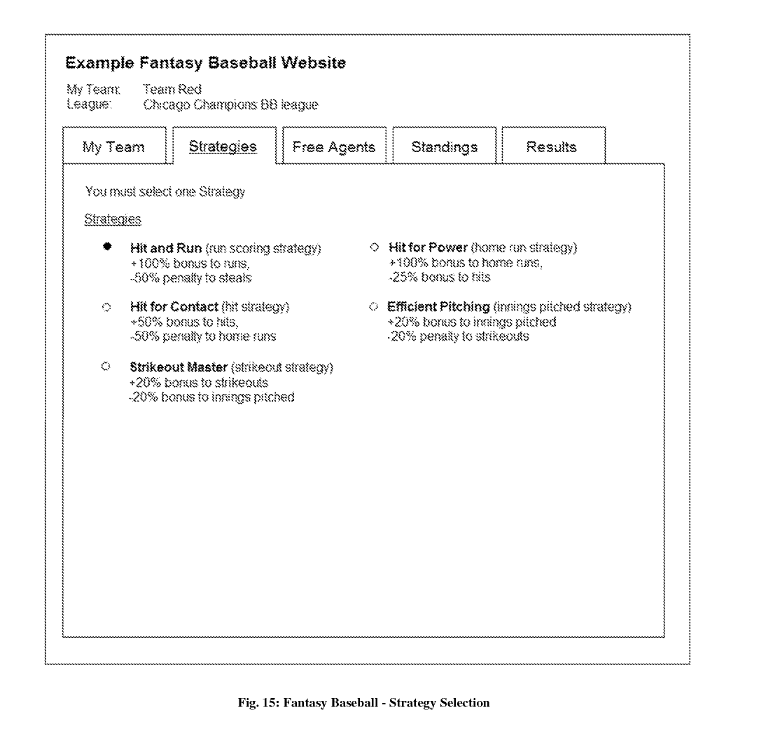

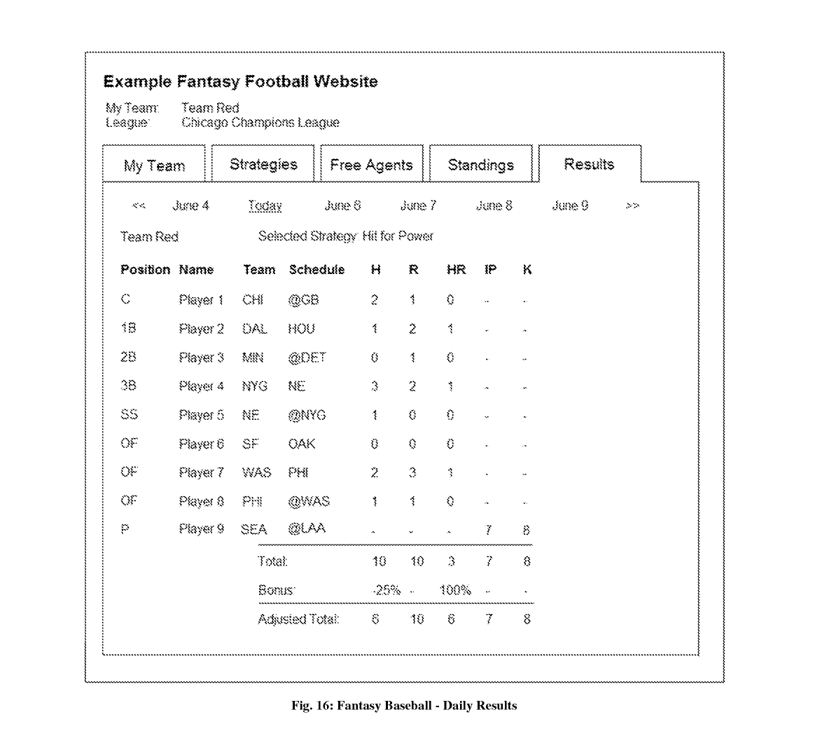

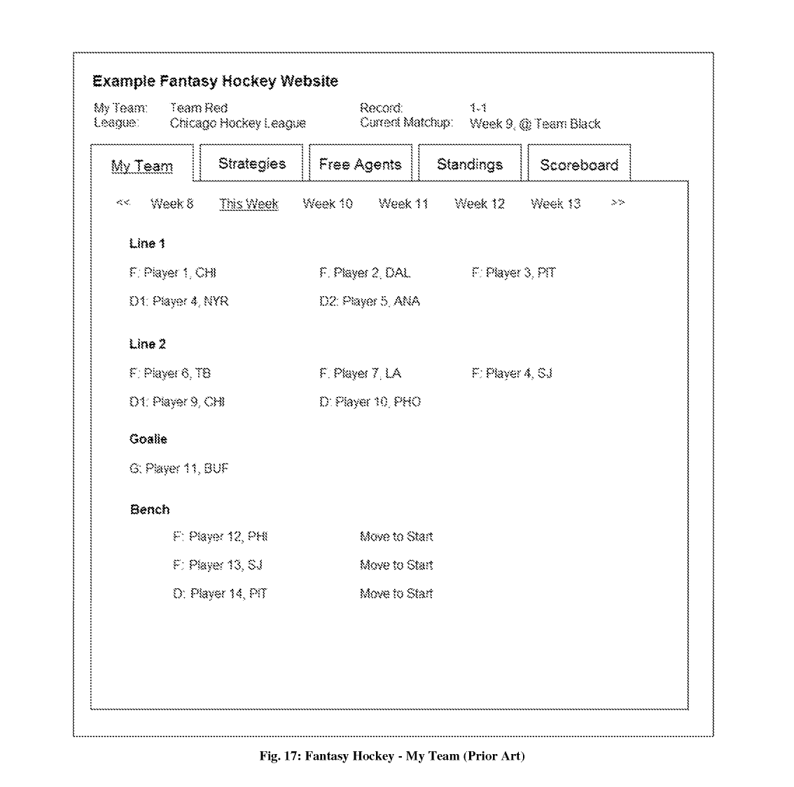

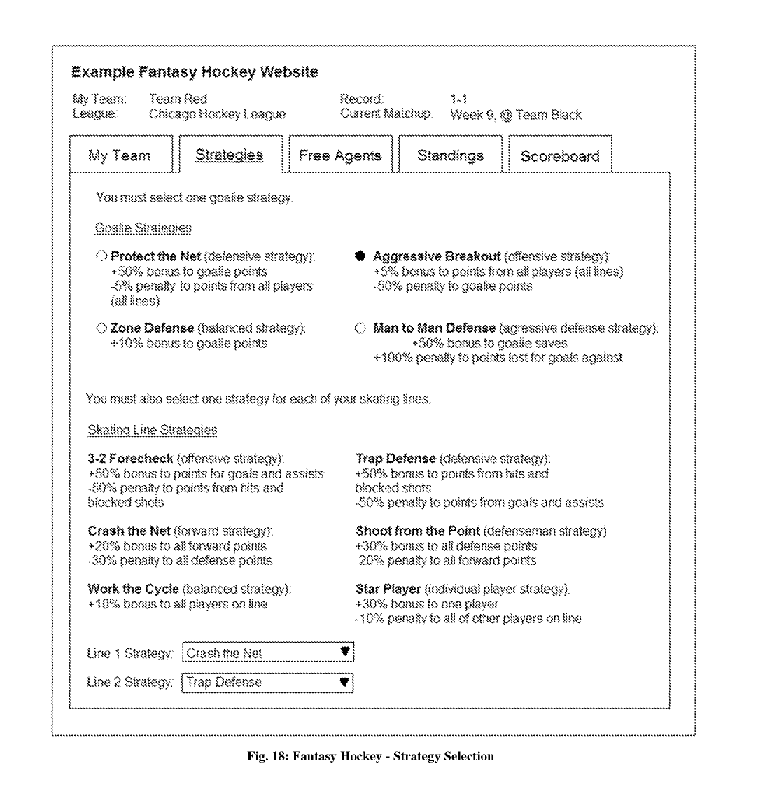

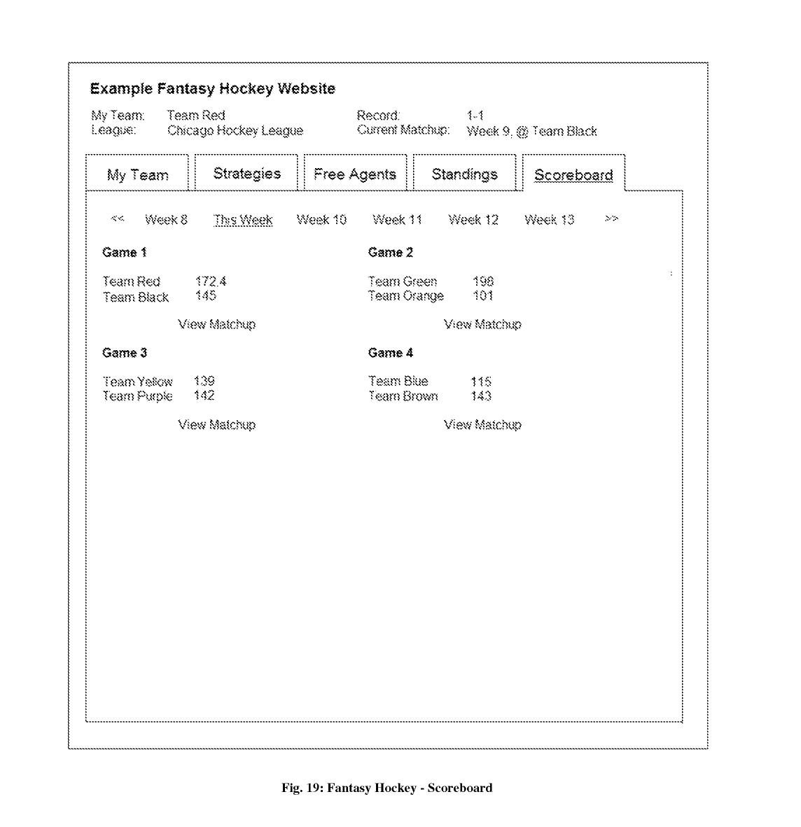

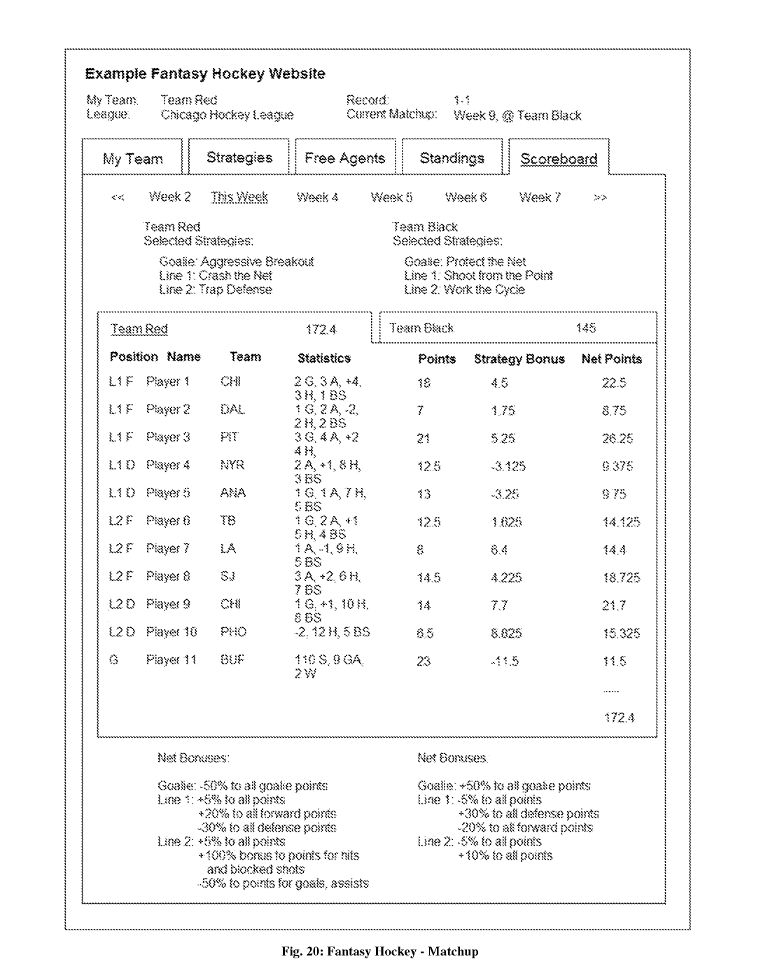

FIG. 8 shows the players who are not on any teams—they are in a free agency pool. These players can be any of the following:
1. Players that were not picked up by the draft; or
2. Players that were picked up in the draft and later dropped from one of the Fantasy teams.

To put it another way, the Free Agents are everyone else in a real life league that is not currently owned by any fantasy team in the fantasy league. The fantasy owners can pick any of these players to their roster (by clicking on “Add to Team” link under the Action column. When a player is added to a roster, another player must be dropped in order to keep the team (starting and benched) size under the roster size restrictions. In this example, the roster size limit is 11 having 8 starting players and 3 benched players.

FIG. 9 shows the preferred embodiment of the invention. Although the strategies listed are labeled as “Advanced,” this embodiment is a relatively simple version of the invention and gives the most value without being too complex for the fantasy player to understand and use. FIG. 9 shows how a fantasy owner must select one of four strategies and one of four counter-strategies for his team. (This is just one of a plethora of different options for coaching strategies. The fantasy sports website or the fantasy league may implement or select various strategy options.) In this case, a coaching strategy is set each week and locked in for the entire week. A different strategy may be selected for Week 4. Each of the strategies (and counter strategies) gives different benefits and drawbacks.

The goal is for the fantasy owner to maximize his or her team's point total for the week based on the team's strengths and weaknesses and how the fantasy owner expects them to perform in the real-life games. For example, if the fantasy owner has a top quarter back and that quarterback has a favorable matchup that week, the fantasy owner will generally want to give a bonus to the quarterback. The fantasy owner may want to use the “Star Player” strategy to give his quarterback 50% bonus points.

The fantasy owner also needs to anticipate what counter-strategy his or her opponent will select and try to mitigate those effects. Therefore, if the opposing team (in this case, Team Blue) selected a “Shutdown Star Player” strategy to counter act the likelihood that Team Red would set the “Star Player” strategy for the quarterback. If Team Red has two top-notch players, Team Blue will likely have a tough time selecting the exact star player to use the “Shutdown Star Player” strategy on (note that for the “Star Player” strategy, the same players must be selected by both teams to properly counteract the effects of the strategy). In this case, one of the other counter-strategies might be safer—giving a penalty to all or most of Team Red's players.

Fantasy owners will evaluate teams and situations differently. Some fantasy owners will take more risk with a particular strategy due to knowledge of a particular real-life team or a particular real-life player. Other players may be more risk adverse and may opt for the balanced strategies. Because fantasy owners will have multiple coaching strategy options, it increases the likelihood that the fantasy owners will not have the exact counter-strategy.

FIG. 10 shows the scoreboard after Week 3's games for each team in the league. Team Red beat Team Blue by 5.9 points. Based on results of the Scoreboard, a win or loss is marked in the Standings as shown in FIG. 6. The user can select the “View Matchup” link to see details about the point totals.

FIG. 11 shows the details of the matchup between Team Red and Team Blue in week 3. The strategies selected by the fantasy owners are shown at the top. Team Red chose the Spread Formation and the Crowd the Box strategies. Team Blue chose the Split the Back Formation and the Limit Star Player for Player 1 strategies.

Note that Team Red anticipated Team Blue's strategies and Team Blue did not gain or lose any points due to the strategies selected. According to the Split Back formation strategy selected by Team Blue, the Team Blue quarterback got a 20% penalty. According to the Crowd the Box counter-strategy selected by Team Red, the Team Blue quarterback got a 20% bonus. In combination, this bonus and penalty evened out for the quarterback position.

This is just an example of various strategies. The bonus/penalty values may be changed for better balance.

As another example, in real-life football, the first line (or first line player) gets played more than the second line (or second line player). Therefore in fantasy football, to mimic this strategy, the present invention would give the first line (or first line player) a bonus and give the second line (or second line player) a penalty.

### EXAMPLE FANTASY BASEBALL COACHING STRATEGIES—ROTISSERIE SCORING

To demonstrate that the inventions disclosed herein may be applied in a rotisserie scoring format, an example of an implementation of the invention is detailed below for fantasy baseball which commonly uses rotisserie scoring.

The player positions common in baseball include, but are not limited to, catcher, first base, second base, third base, short stop, outfield, and pitcher.

There are different levels of implementation of this invention. Two such levels and example strategies are laid out below and have increasing levels of sophistication.
Basic Strategies: (only bonuses to owner's team)
   Hit and Run (run scoring strategy): Gives 100% bonus to runs earned
   Hit for Power (home run strategy): Gives 100% bonus to home runs earned
   Hit for Contact (batting average strategy): Gives 50% bonus to hits earned
   Speed on the Bases (base-stealing strategy): Gives 100% bonus to steals earned
   Efficient Pitching (innings pitched strategy): Gives 20% bonus to innings pitched
   Strikeout Master (strikeout strategy): Gives 20% bonus to strikeouts
Intermediate Strategies: (bonuses with associated penalties to owner's team)
   Hit and Run (run scoring strategy): Gives 100% bonus to runs earned, but gives 50% penalty for steals earned
   Hit for Power (home run strategy): Gives 100% bonus to home runs earned, but gives 25% penalty to hits earned
   Hit for Contact (batting average strategy): Gives 50% bonus to hits earned, but gives 50% penalty to home runs earned
   Efficient Pitching (innings pitched strategy): Gives 20% bonus to innings pitched, but gives 20% penalty to strikeouts
   Strikeout Master (strikeout strategy): Gives 20% bonus to strikeouts, but gives 20% penalty to innings pitched

FIG. 15 shows a fantasy owner selecting a strategy. This mimics the ability of a real-life baseball coach assess and utilize the strengths of his team. Although only one strategy is permitted in this example, multiple strategies may be used if the league owner so permits. Strategies may be changed as often as every day.

### FANTASY BASEBALL EXAMPLE—ROTISSERIE SCORING

Baseball is used as a second example to illustrate how the invention can be used for rotisserie scoring leagues Unlike head-to-head points scoring, rotisserie scoring system is based off of actual statistics rather than points.

In the preferred embodiment, each fantasy team will have the ability to select/change strategies every day. FIG. 12 through FIG. 14 are used to discuss the background of the invention and are prior art. FIG. 15 shows an embodiment of the invention of possible Strategies that a fantasy owner would be able to select.

FIG. 12 shows the standings for the Chicago Champions BB League, a fantasy football league. The view of the standings is that of one of the fantasy owner of Team Red at some point during or at the end of the season. Note that Team Red is in second place.

FIG. 13 shows Team Red's roster as of June 3rd. These players that are currently on Team Red were either:
1. Selected in the draft; or
2. Acquired through free agency or by trading with other owners since the draft.

The players in the “Starting” slots (C, 1B, 2B, 3B, OF(3), P) are the only players that score points for the fantasy team each week. The number of starting slots is limited based on league settings set by the league manager. The fantasy owner needs to choose the starting players based on which players have the greatest chance of accumulating the most points in a given week. The bench is used to reserve players to play in the following weeks or to prevent other fantasy owners from acquiring the players. On this screen a fantasy owner will select the players for the starting line up and move the remaining players to the bench (by clicking on the “Move to Bench” link under the Action column). Depending on the league settings, the fantasy owner will likely have to select a lineup each week.

FIG. 14 shows the players who are not on any teams—they are in a free agency pool. These players can be any of the following:
1. Players that were not picked up by the draft; or
2. Players that were picked up in the draft and later dropped from one of the Fantasy teams.

FIG. 15 shows the preferred embodiment of the invention as applied to fantasy baseball. FIG. 15 shows how a fantasy owner must select one of five strategies. (The strategies shown are just one of a plethora of different options for coaching strategies. The fantasy sports website or the fantasy league may implement or select various strategy options.) In this case, a coaching strategy is set either at the beginning of the season or each time the fantasy owner changes the starting roster.

In the rotisserie scoring system, the goal is for the fantasy owner to maximize his or her team's all-around statistical gains relative to the other fantasy teams in the league across the entire season. Based on (1) the team's strengths and weaknesses, (2) how the fantasy owner expects the players to perform in the real-life games, and (3) what statistical categories the fantasy owner needs to score in, the coaching strategy for the team may be adjusted accordingly. For example, consider a situation where the fantasy team primarily has two types of hitters: several power hitters who get few hits, but many of them are home runs, and several contact hitters who get lots of base hits, except few of them are for home runs. The power hitters will likely generate a significant number of home runs, while the contact hitters will generate a lot of base hits. The coaching strategy and starting lineup decisions will be based on what statistics the fantasy owner would like to prioritize gaining for the team. If the team is lacking in home runs, it would make sense to start the power hitters over the contact hitters and choose the Hit for Power strategy. If the team is lacking in hits, it would make sense to do the opposite and start the contact hitters over the power hitters and choose the Hit for Contact strategy.

FIG. 16 shows the results on June 5^{th} after setting the Hit for Power intermediate level strategy on June 3^{rd}. The Hit for Power intermediate level strategy gives 100% bonus to home runs earned, but gives 25% penalty to hits earned. The points earned for a particular game will be recorded as the fantasy owner's statistics which will be tallied up at the end of the season to determine a league winner.

This is just an example of various strategies. The bonus/penalty values may be changed for better balance.

As another example, in real-life baseball, a batting order of 1 through 9 is set. Top batters in the order naturally Alternatively get more at-bats than the other players. Therefore in fantasy baseball, to mimic this strategy, the present invention would give a bonus to the top batters in the batting order and a penalty to the lower batters in the batting order. Further, in real-life baseball, the third batter, even if not a strong player, would likely have (or attain) better statistics merely due to the fact that the third batter bats immediately ahead of the fourth batter, who is generally the teams' best hitter. Therefore, in fantasy baseball, an additional bonus could be given to players based on their batting order placement.

### EXAMPLE FANTASY HOCKEY COACHING STRATEGIES

In real life hockey, teams are organized into multiple lines of offense and defense. In fantasy hockey, there are typically three types of players: forwards, defense, goalies. To mimic the real life lines, in fantasy hockey, the league manager may require that teams are organized by lines and thus allow the fantasy owner to set different strategies per line. For example—a team may be organized into 1 goalie and 2 skating lines, Line 1, and Line 2. Each skating line consists of 3 forwards and 2 defensemen. Each line can be assigned an individual strategy with the goal of maximizing their potential for scoring fantasy points.

An example of a fantasy hockey head to head scoring system is as follows:

| Statistic | Fantasy Points |
|---|---|
| Goal (G) | 3 for forwards, 4 for defense |
| Assist (A) | 2 for forwards, 3 for defense |
| +/− | 1/−1 |
| Hits (H) | 0.5 |
| Blocked Shot (BS) | 0.5 |

Possible strategies for a fantasy hockey league with teams organized into lines are listed below:
Goalie Strategies
   Protect the Net (defensive strategy): Goalie points increased by 50%, but all other players receive −5% penalty
   Aggressive Breakout (offensive strategy): All players receive 5% bonus, but goalie receives −50% penalty
   Zone Defense (balanced strategy): Goalie points increased by 10%
   Man to Man Defense (aggressive defense strategy): Fantasy points for each goalie save is worth 50% more, but fantasy points lost for goals allowed is increased by 100%
Skating Line Strategies:
   3-2 Forecheck (offensive strategy): Goals and assists are worth 50% more fantasy points, but fantasy points scored from hits and blocked shots receive 50% penalty
   Trap Defense (defensive strategy): Hits and blocked shots are worth 100% more fantasy points, but fantasy points from goals and assists receive 20% penalty
   Crash the Net (forward strategy): Forwards receive 20% bonus to all fantasy points scored, but defenseman receive 30% penalty
   Shoot from the Point (defenseman strategy): Defensemen receive 30% bonus to all fantasy points scored, but forwards receive 20% penalty
   Work The Cycle (balanced strategy): All players receive 10% bonus to all fantasy points scored
   Star Player (individual player strategy): One selected player on the line receives a 50% bonus to all fantasy points scored, but all other players on the line receive a 20% penalty

Consider a fantasy team that consists of the following players: a top goalie, several high scoring forwards, several solid defensive forwards, but relatively weak defensemen. Possible line strategies may include:
Goalie: Protect the Net—Since the team has a top goalie, it is a solid strategy to give the goalie a boost.
Line 1: Crash the Net—The high scoring forwards would be grouped on the first line to maximize the potential of this strategy, along with the two weakest defensemen to minimize the defensive penalty.
Line 2: Trap Defense—The best defensive players who get the most hits and blocked shots would be grouped on this line to take advantage of the trap defense strategy.

As another example, in real-life hockey, a team's first line gets more ice time than the second line. Therefore in fantasy hockey, to mimic this strategy, the present invention would give the first line a bonus and the second line a penalty.

### FANTASY HOCKEY EXAMPLE—HEAD TO HEAD AND ROTISSERIE SCORING

Hockey is used as a third example to illustrate how the invention can be used to set line strategies.

In the preferred embodiment, both fantasy teams in a matchup select one goalie strategy and two line strategies as shown in FIG. 18. FIG. 17 shows Team Red's roster going into week 9. Note that the team owner sets the roster for the two separate lines. The players not on the bench are the only players that score points for the fantasy team each week.

FIG. 18 shows the preferred embodiment of the invention as applied to fantasy hockey. Separate strategies are selected for each line. (This is just one of a plethora of different options for coaching strategies. Strategies and strategy selection may be more or less detailed.)

As in the previous examples, the goal is for the fantasy owner to maximize his or her team's point total for the week based on the team's strengths and weaknesses and how the fantasy owner expects them to perform in the real-life games.

FIG. 19 shows the scoreboard after Week 9's games for each team in the league.

FIG. 20 shows the details of the matchup between Team Red and Team Black in week 9. The strategies selected by the fantasy owners are shown at the top. Note that each fantasy owner chose different strategies for each line. Also note that the player that would have received the most points (the goalie) was penalized half of his points due to the strategies selected by Team Red's owner's strategy selections. On the other hand, Player 10 more than doubled his points.

Although illustrative embodiments of the present invention and various modifications thereof have been described in detail herein with reference to the accompanying drawings, it is to be understood that the invention is not limited to these precise embodiment and the described modifications, and that various changes and further modifications may be effected therein by one skilled in the art without departing from the scope or spirit of the invention as defined in the appended claims.

I claim:

1. One or more computer-readable storage media on which is embedded one or more sets of computer-executable instructions for managing a fantasy league, the instructions comprising:
a. a coaching strategy code segment that allows a first fantasy owner to set one or more coaching strategies for one of the one or more players.

2. The one or more computer-readable storage media of claim 1 wherein the one or more coaching strategies comprises one or more of:
a. allowing the first fantasy owner to give a bonus to a player;
b. allowing the first fantasy owner to give a bonus to a line;
c. allowing the first fantasy owner to give a penalty to a player; and
d. allowing the first fantasy owner to give a penalty to a line.

3. The one or more computer-readable storage media of claim 1 wherein the one or more coaching strategies comprises allowing the first fantasy owner to give a bonus to a first player, wherein the bonus causes a penalty to be placed on one or more of: the first player, a second player, a line, an opposing player, an opposing team or an opposing line.
